(19) United States
(12) Patent Application Publication
(10) Pub. No.: US 2019/0242098 A1
(43) Pub. Date: Aug. 8, 2019

(54) SYSTEMS AND METHODS FOR RECOVERING WATER FROM AIR

(71) Applicant: Moses A. WEST, San Antonio, TX (US)

(72) Inventor: Moses A. WEST, San Antonio, TX (US)

(21) Appl. No.: 16/269,246

(22) Filed: Feb. 6, 2019

Related U.S. Application Data
(60) Provisional application No. 62/658,220, filed on Apr. 16, 2018.
(60) Provisional application No. 62/627,535, filed on Feb. 7, 2018.

(51) Int. Cl. E03B 3/28; F24F 13/22; F24F 3/153; C02F 1/68

(52) U.S. Cl. CPC E03B 3/28; F24F 13/222; F24F 2003/1446; C02F 1/68; F24F 2013/228; F24F 3/153

(57) ABSTRACT

A refrigerator cycle may include a condenser and an evaporator. A cross flow heat exchanger may be constructed and arranged to pass air in first and second directions and transfer energy between air in the first direction and air in the second direction. A fan may be constructed and arranged to draw air from the evaporator over the condenser and to create air flow through the cross flow heat exchanger in the first direction, past the evaporator, through the cross flow heat exchanger in the second direction, and past the condenser. The evaporator may cause water in the air to condense.

### CROSS-REFERENCE TO RELATED APPLICATIONS

This application claims priority from U.S. Provisional Patent Application No. 62/627,535, entitled “Apparatus For Recovering Water From Air,” filed Feb. 7, 2018; and from U.S. Provisional Patent Application No. 62/658,220, entitled “Apparatus For Recovering Water From Air,” Filed Apr. 16, 2018; the entirety of each of which is incorporated by reference herein.

### BRIEF DESCRIPTION OF THE DRAWINGS

FIG. 1 shows a refrigeration cycle diagram according to an embodiment of the disclosure.

FIGS. 2 and 3 show a refrigeration system with cross flow air exchangers according to an embodiment of the disclosure.

FIG. 4 shows a refrigeration system with cross flow air exchangers and additional equipment according to an embodiment of the disclosure.

FIG. 5 shows a refrigeration system with cross flow air exchangers and a secondary refrigeration loop according to an embodiment of the disclosure.

FIG. 6 shows a perspective view of a structure configured to house a refrigeration system according to an embodiment of the disclosure.

FIG. 7 shows a perspective view of an evaporator coil according to an embodiment of the disclosure.

FIGS. 8-12 show cutaway views of a structure configured to house a refrigeration system according to an embodiment of the disclosure.

### DETAILED DESCRIPTION OF SEVERAL EMBODIMENTS

Systems and methods described herein may recover water from air. For example, some embodiments may include a refrigerator cycle including a condenser and an evaporator. A fan may draw air from the evaporator over the condenser. A cross flow heat exchanger may pass air in first and second directions and transfer energy between air in the first direction and air in the second direction. The fan may create air flow through the cross flow heat exchanger in the first direction, past the evaporator, through the cross flow heat exchanger in the second direction and past the condenser. Accordingly, the evaporator may cause water in the air to condense. Some embodiments may include both a primary refrigerator cycle including a condenser and an evaporator and a secondary refrigerant loop including a secondary heat exchanger, a secondary pump, and refrigerant disposed in the secondary refrigerant loop. The secondary refrigerant loop may perform the aforementioned condensation operations while the primary cycle may provide cooling. Embodiments described herein may perform efficient and effective recovery of water that may be used for any purpose.

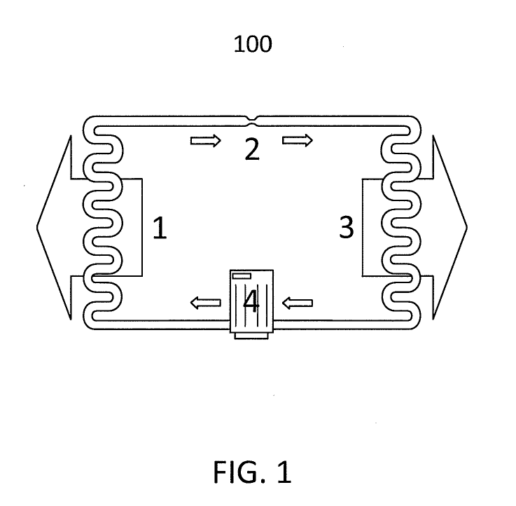

FIG. 1 shows a refrigeration cycle 100 diagram according to an embodiment of the disclosure. A refrigeration cycle 100 may include a condensing coil 1, an expansion valve 2, an evaporator coil 3, and a compressor 4. The refrigeration cycle may perform cooling as follows. System refrigerant may start its cycle in a gaseous state. The compressor 4 may pump the refrigerant gas up to a high pressure and temperature. From there, refrigerant may enter a heat exchanger 1 (sometimes called a condensing coil or condenser) where it may lose energy (heat) to the outside, cool, and condense into its liquid phase. An expansion valve 2 (also called metering device) may regulate the refrigerant liquid to flow at a desired rate. The liquid refrigerant may be returned to another heat exchanger 3 where it may be allowed to evaporate; hence the heat exchanger 3 is often called an evaporating coil or evaporator. As the liquid refrigerant evaporates it may absorb energy (heat) from the inside air, return to the compressor 4, and repeat the cycle. In the process, heat may be absorbed from a first zone (e.g., indoors) and transferred to a second zone (e.g., outdoors), resulting in cooling of the second zone (e.g., a building interior).

In variable climates, the system may include a reversing valve that switches from heating in winter to cooling in summer. By reversing the flow of refrigerant, the heat pump refrigeration cycle may be changed from cooling to heating or vice versa. This may allow a facility to be heated and cooled by a single piece of equipment by the same hardware and functions.

The condenser 1 may remove heat given off during the liquefaction of vaporized refrigerant. Heat may be given off as the temperature drops to condensation temperature. Then, more heat (e.g., the latent heat of condensation) may be released as the refrigerant liquefies. Condensers 1 may be air-cooled and/or water-cooled condensers, named for their respective condensing media. The refrigerant may be forced through the condenser 1. The condenser 1 may include tubes with external fins. In order to remove as much heat as possible, the tubes may be arranged to maximize surface area. Fans may be used to increase airflow by forcing air over the surfaces, thus increasing the condenser 1 capability to give off heat.

The evaporator 3 may perform the actual cooling. Because its function is to absorb heat into the refrigeration system, the evaporator 3 may be placed in the area to be cooled. The refrigerant may be let into the evaporator 3 at a rate governed by a flow control device 2, and eventually may be released to the compressor 4. The evaporator 3 may include finned tubes, which may absorb heat from the air blown through a coil by a fan. Fins and tubes may be made of metals with high thermal conductivity to maximize heat transfer, such as, for example, stainless steel. The refrigerant may vaporize from the heat it absorbs in the evaporator 3.

In some systems the condenser 1 and the evaporator 3 may be cooled or regulated by an electrical or mechanical motor attached to a fan that pulls air through the coils in two separate and divided processes within the HVAC systems. These two separate systems may increase the amount of electrical power used to operate the systems, corresponding to a proportional increase in the size and weight of the HVAC system, thus decreasing the overall power consumption, processing, and control of airflow within the system. For example, in a standard HVAC system, there may be fans to control the temperature regulation of the heat exchanger. The use of these fans may increase the electrical load (e.g., parasitic electrical load) thus increasing the kWh per liter. Using the cross-flow air exchangers by redirecting the cool air back over the hot heat exchanger, some embodiments disclosed herein may eliminate the high voltage fans used to cool the condenser 1 and the evaporator 3. Eliminating these fans may decrease the electrical load, thereby reducing the cost per measurement of water (e.g., cost per gallon or liter).

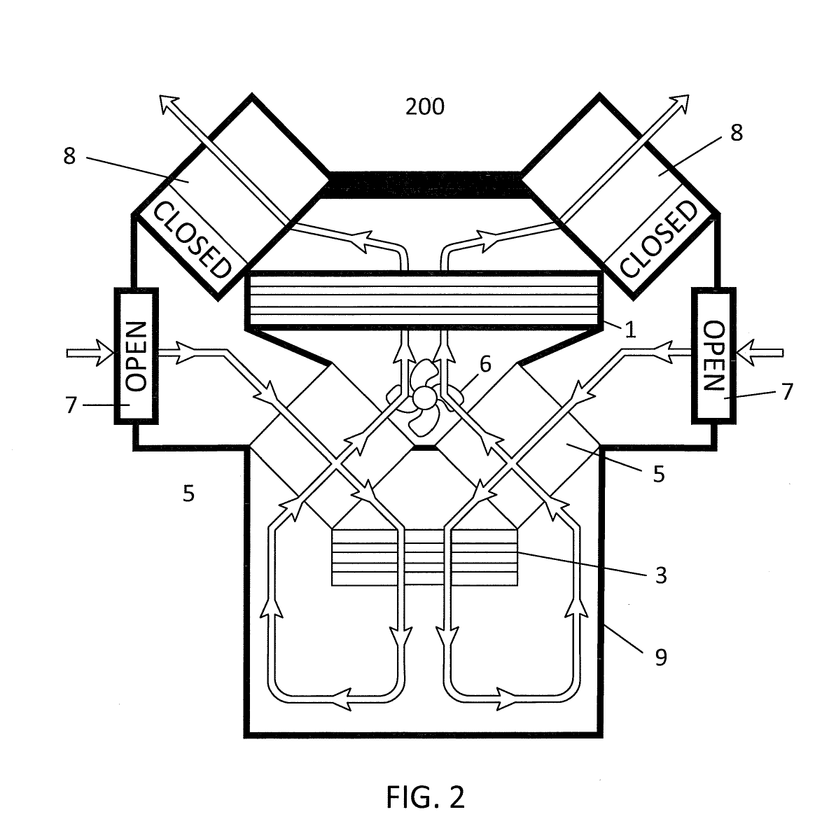

FIG. 2 shows a refrigeration system 200 (also referred to as a heating, ventilation, and air conditioning (HVAC) system) with cross flow air exchangers 5 according to an embodiment of the disclosure. The use of cross flow air (heat) exchangers 5 may allow the HVAC system 200 to function without a separate electrical cooling fan to remove heat from the condensing coil 1. With the use of the cross air exchangers 5, the air that enters the system 200 may be pulled over the evaporator coil 3 in one direction to produce water. The water may be collected in a stainless steel container 9 or other type of collection apparatus. The water in the container 9 may be exposed to ultraviolet light or other treatment system in some embodiments (e.g., to prepare the water for use as potable water). Upon exiting the evaporator 3, the air may be pulled back through the cross flow air exchangers 5 in the desired direction to the condensing coil 1 by a fan 6 (e.g., an electric fan). The fan 6 may also pull the air out of the system 200 to cool and maintain the temperatures of the condenser coil 1. Residual cooling of the cross flow air exchangers 5 may decrease the temperature of the incoming air prior to contact with the evaporator coil 3. This reduction in air temperature may increase the efficiency of the water generator, because cooler air entering the system 200 may reach the dew point necessary to produce water faster. Thus, the amount of electrical consumption for the compressor 4 may be reduced, increasing the energy efficiency and water production of the system 200.

In some embodiments, cool water collected from the air may pass an additional coil or radiator located on the back end of cross flow air exchangers 5 to provide a further decrease in air temperature.

The cross flow heat or air exchangers 5 may reduce the amount of electrical power used to power the fan motor 6 within atmospheric water generators. For example, the amount of electrical power used may reduce by 50 percent in some embodiments. The cross flow heat or air exchangers 5 may realize this reduction by cooling air prior to use.

For example, the cross flow air exchangers 5 may cool the air prior to the air entering or passing through the condenser coil 1. This additional cooling may reduce the electrical consumption by requiring less fan speed to pull air through the condenser 1 to cool the coolant prior to returning to the compressor 4, thereby increasing efficiency.

The cross flow heat or air exchanger 5 may cool the air prior to the air entering the evaporator coil 3. This may lower the air temperature closer to the dew point to produce higher volumes of water.

In some embodiments, the cross flow air exchanger 5 may produce a significant amount of water within the air exchanger 5 itself through condensation when the temperature has been lowered by the cool air passing through one of the two directions within the exchanger 5 on the path to the condenser coil 1 as pulled by the fan 6.

With the use of a cross flow heat or air exchangers 5, some embodiments of the HVAC system 200 may be configured without a separate electrical cooling fan to remove heat from the condensing coil 1. With the use of the cross heat and air exchangers 5, the air that enters the system 200 may be pulled over the evaporator coil 3 in one direction. Upon exiting the evaporator 3, the air may be pulled through the cross flow heat or air exchangers 5 in the desired direction to the condensing coil 1 with the same electrical fan 6 that pulls the air out of the system to cool the condenser coil 1.

HVAC system 200 may be configured to function across a wide range of atmospheric temperatures. For example, system 200 may be configured to operate differently above and below a certain temperature, for example 5° Celsius in some embodiments. This may allow the system 200 to function in high latitudes and high elevations that may experience extreme water shortages.

For example, FIG. 2 shows a configuration useful for air having a temperature above a threshold (e.g., 5° Celsius or some other temperature threshold). In this example, air may enter the system 200 through open vents 7. Cross flow heat exchangers 8 may have vents closing a second air flow direction. As a result, air may enter the system through vents 7 and exit the system through cross flow heat exchangers 8.

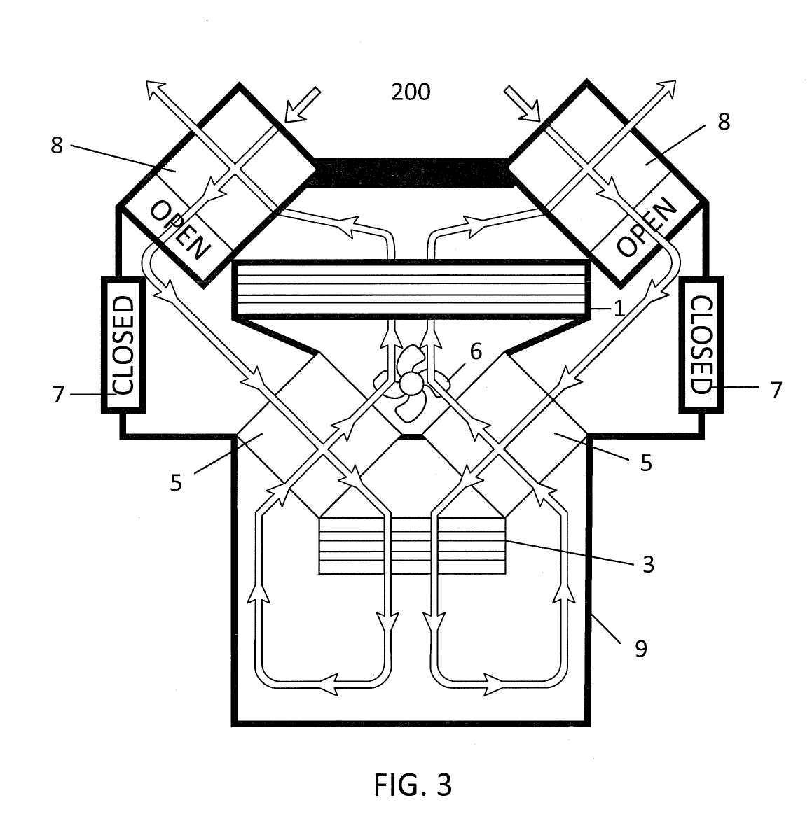

FIG. 3 shows the HVAC system 200 operating at a temperature below the threshold. In this case, the vents 7 may be closed, and the vents in cross flow heat exchangers 8 may be opened. As a result, air may enter the system through cross flow heat exchangers 8. Air warmed by condenser coil 1, flowing through cross flow heat exchangers 8 in the other direction, may warm the incoming air. The air from cross flow heat exchangers 8 may then flow through cross flow heat exchangers 5 before being cooled by evaporator coil 3. The air then may pass in the other direction through cross flow heat exchangers 5, before being warmed by condenser coil 1 and exhausted through cross flow heat exchangers 8.

This method of operating the system 200 may allow for the production of water at lower temperatures than the threshold temperature by using the heat produced from the condensing coil 1 through a series of cross flow air exchangers 5 and 8 and louvers. This warm air may be directed to the evaporator coil 3 utilizing the residual heat trapped in the cross flow air exchanger 8. The direct heat from the condenser coils 1 may be unusable for moisture generation, as the moisture may have already been removed from this volume of air when it passed over the evaporator coils 3.

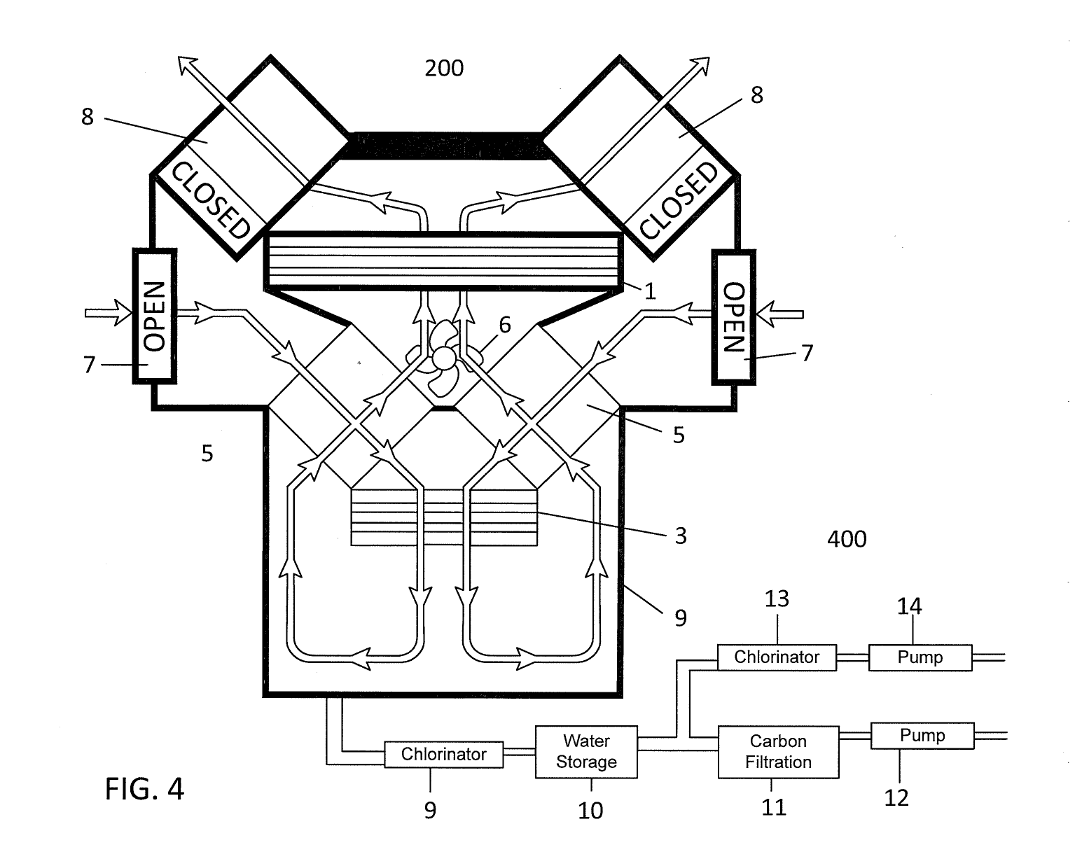

FIG. 4 shows a refrigeration system 200 with cross flow air exchangers 8 and additional equipment 400 according to an embodiment of the disclosure. For example, the system 200 may be coupled to treatment equipment 400 that may process the water recovered by the system 200.

For example, water condensed by evaporator 3 may pass through chlorinator 9 to water storage tank 10. As water is needed for some use outside system 200, pump 12 may draw water out of storage tank 10 through a carbon filtration device 11 or other filtration device. For example, the water may pass through a NSF-61 certified carbon micron filter.

If more chlorinated water is needed, pump 14 may draw water from storage tank 10 through second chlorinator 13. The addition of a second chlorination system 13 and pump 14 may be employed for the decontamination of people, water storage devices, and surrounding area in proximity to the atmospheric water generator. For example, the second water pump 14, associated chlorination tank 13, and an additional water spigot may introduce a high dose of chlorine into the water to prevent water borne disease. The second separate system may allow for decontamination in conjunction with water production with the regulated therapeutic dose of chlorination from chlorinator 9 for drinking water.

The filtration and/or chlorination may allow the collected water to be used for drinking water and/or other functions requiring such treatment. For example, many local, state, and/or federal regulations require standing water to have a therapeutic dose of chlorination added. Active carbon filtration may strip off the chlorination when the water passes through the carbon filter. Although the water may be exceptionally clean upon collection, it may possibly be passed to water containers that may have some residual contamination, thus contaminating the pure water dispensed by the water generator and the carbon filtration.

The second chlorinator 13 may add additional chlorine to replace the chlorine that has been stripped away in the active carbon filtration process. The addition of the additional chlorination may have at least two purposes. The first purpose may be to provide a therapeutic dose of chlorination to decontaminate water containers to which the water is transferred or in which the water is later stored. The second purpose may be to decontaminate large areas of land and people using a high-pressure water pump to spray contaminated surfaces. The second chlorinator 13 may be adjustable to allow an increase or decrease in the amount of chlorination that is added. For example, adjusting the second chlorinator 13 to provide a higher level of chlorination than is required for drinking water treatment may allow the system to be used as a decontamination device for water borne diseases.

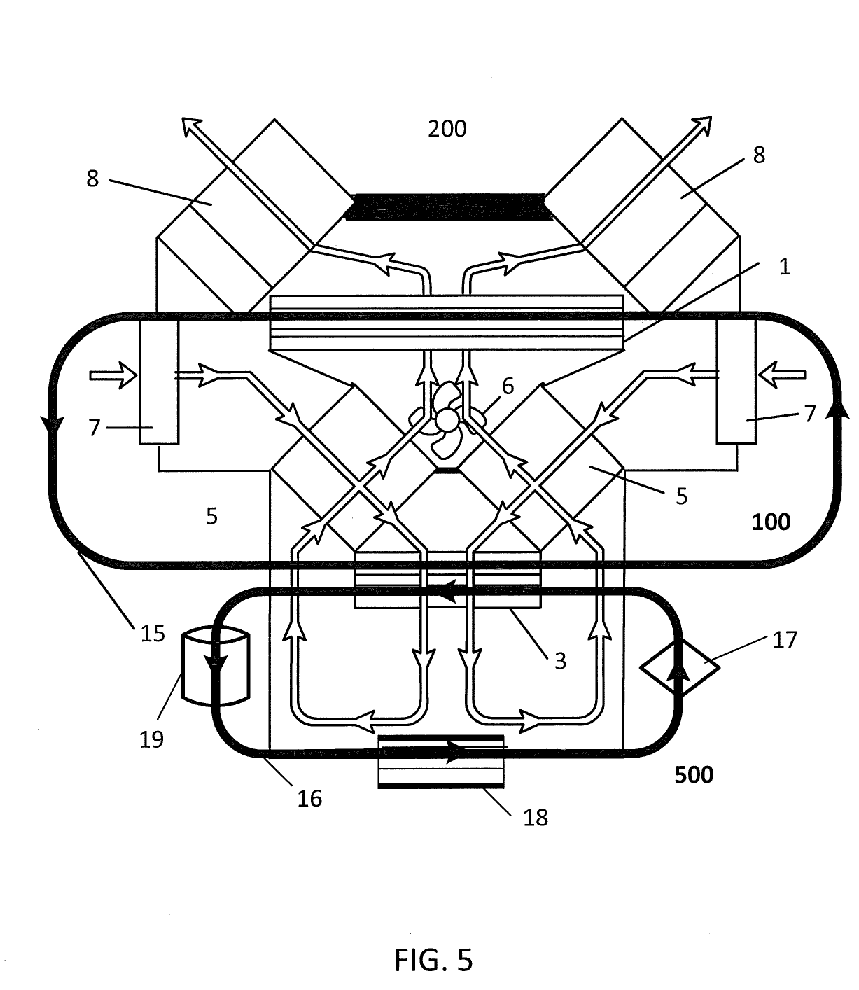

FIG. 5 shows a refrigeration system with cross flow air exchangers 5 and a secondary refrigeration loop 500 according to an embodiment of the disclosure. In this example embodiment, the heat exchanger 3 may cool a secondary refrigeration loop 500 in addition to or rather than cooling the air directly. The heat exchanger 3 may include piping from the primary refrigeration cycle 100 described above and piping 16 for the secondary refrigeration loop 500 so that the piping from the primary refrigeration cycle 15 cools the piping for the secondary refrigeration loop 16. A pump 17, such as a scroll refrigerant compressor, may move refrigerant in the secondary refrigeration loop 500 from heat exchanger 3 to another heat exchanger 18 that may cool air to cause water to condense as described above with respect to the previous embodiments. The other heat exchanger 18 may be made of stainless steel or another suitable material. This arrangement may allow condenser 1, expansion valve 2, heat exchanger 3, and compressor 4 to be separated from the remaining equipment described in FIGS. 2-4 above. In this embodiment, the refrigerant in the secondary refrigeration loop 500 may be ethylene or propylene glycol (e.g., inhibited propylene glycol) or another non-toxic coolant. The secondary refrigeration loop 500 may include an insulated refrigerant tank 19 in some embodiments. The secondary refrigeration loop 500 may be low pressure compared to the primary refrigeration cycle in some embodiments. In some embodiments, water collected by the secondary refrigeration loop 500 may be treated (e.g., by components 400 of FIG. 4).

In some embodiments, the secondary refrigeration loop 500 may allow for the size of the atmospheric water generator system overall to be increased without increasing the size of the HVAC system 200 due to reducing the temperature of the second coolant without having to increase power consumption. The second coolant tank 19 may be any size. Increasing the size of the water production capacity of the AWG unit without increasing the size of the corresponding additional HVAC system may result in a corresponding decrease in power consumption with an increase in water production capabilities. The size of the entire mechanism may increase as water output increases, but with a considerable reduction in power consumption relative to a system without a secondary refrigeration loop 500.

The dual coolant system and the associated reduction in power consumption may provide additional benefits beyond those described above. For example, as the world gets warmer, the need for air conditioning is becoming more widespread and frequent. The dual coolant system described above may be adapted to home air conditioning and increase energy consumption dramatically. This dual coolant system may be able to accomplish this in several ways.

For example, the compressor 4 may be only used to lower the temperature of the second coolant. When the coolant is sufficiently cooled in the storage tank 19, the compressor may be set to switch off. The amount of coolant in the tank and the temperature of the coolant may determine how long the first system (HVAC) will remain off. The time that the compressor 4 is off may save energy, as the compressor 4 is the most energy intensive part of the refrigeration cycle in many HVAC systems. The coolant from the storage tank 19 may be blown through the evaporator coil into the area that needs to be cooled. The thermostat of the HVAC system may regulate only the pump and fan associated with the storage tank 19. The energy intensive compressor 4 may be able to remain off for extended periods of time. The temperature of the coolant may remain fairly constant for a significant portion of time within the storage tank 19, resulting in lower energy consumption for the system as a whole. Because an HVAC thermostat measures the temperature of the area being cooled, and not the coolant, the fact that the temperature of the coolant may be significantly lower than −10 C while the area being cooled may be regulated at +20 C and above means that the thermostat will not attempt to frequently lower the temperature of the coolant. It may take some time for the second coolant to warm up to a set point for the compressor to kick on and lower the temperature of the second coolant again. This may allow the compressor to run less and need to be replaced less often, saving both energy and money. There may also be a reduction in air contamination from the coils leaking toxic coolants into the air in the living space.

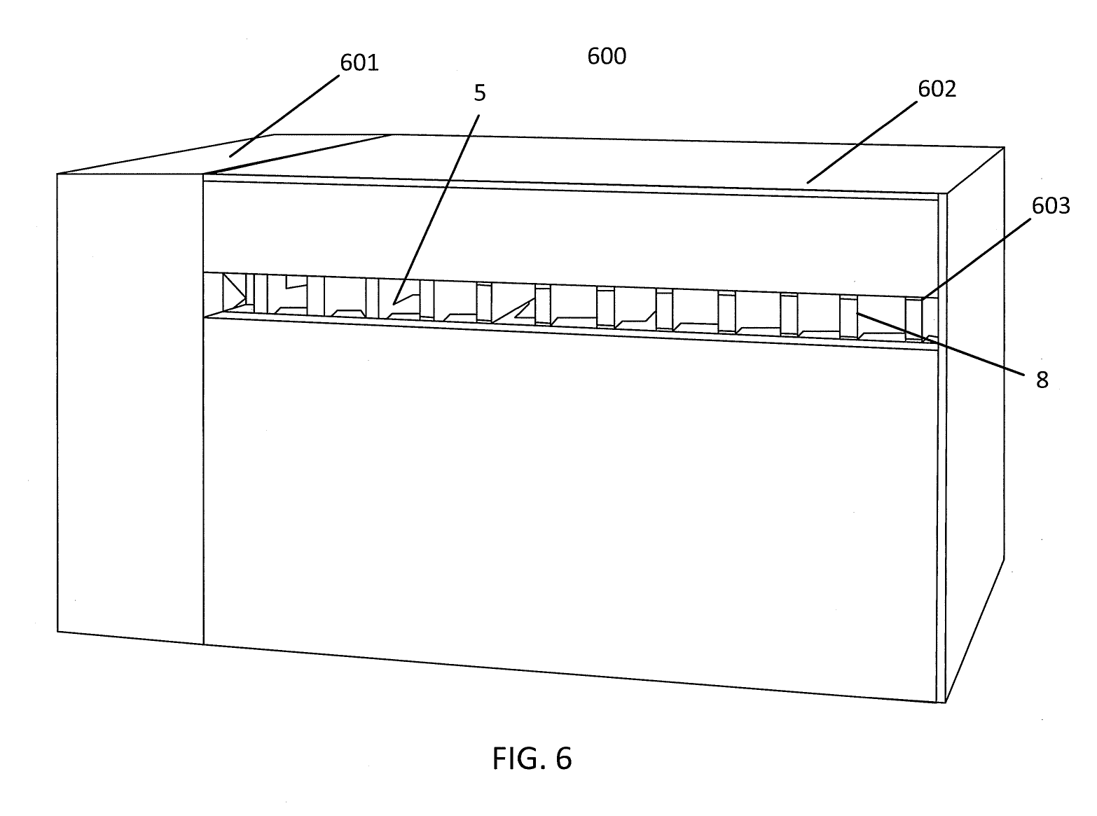

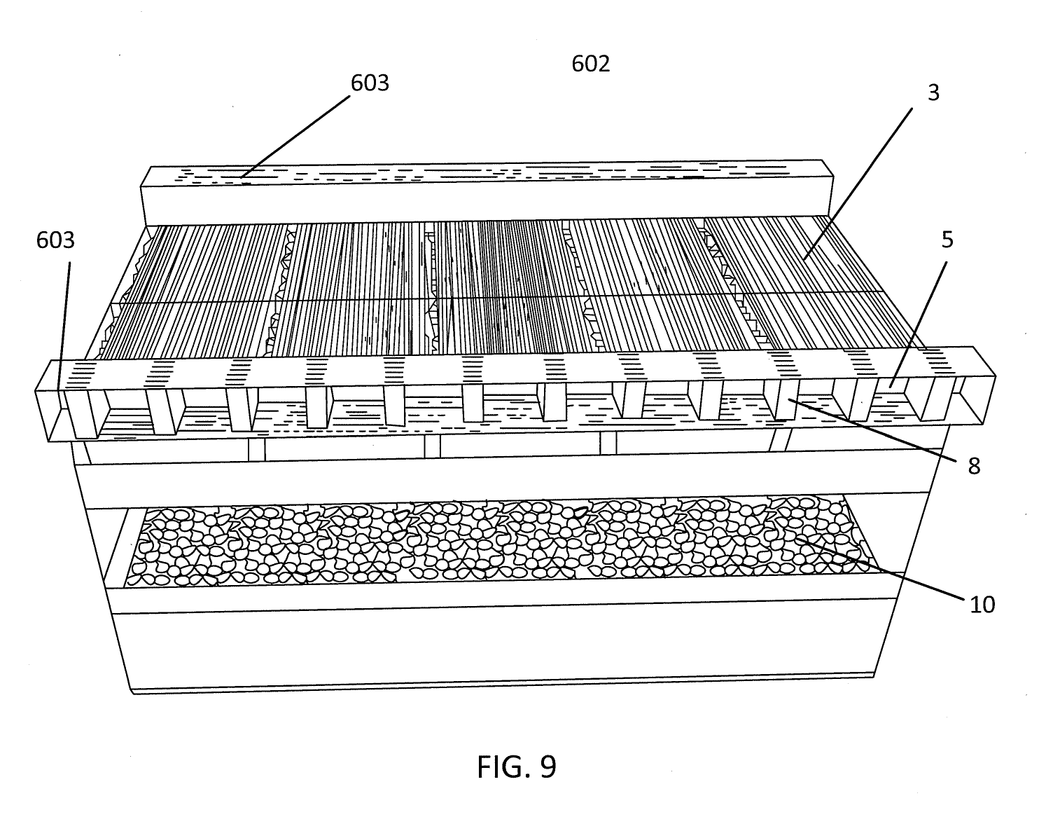

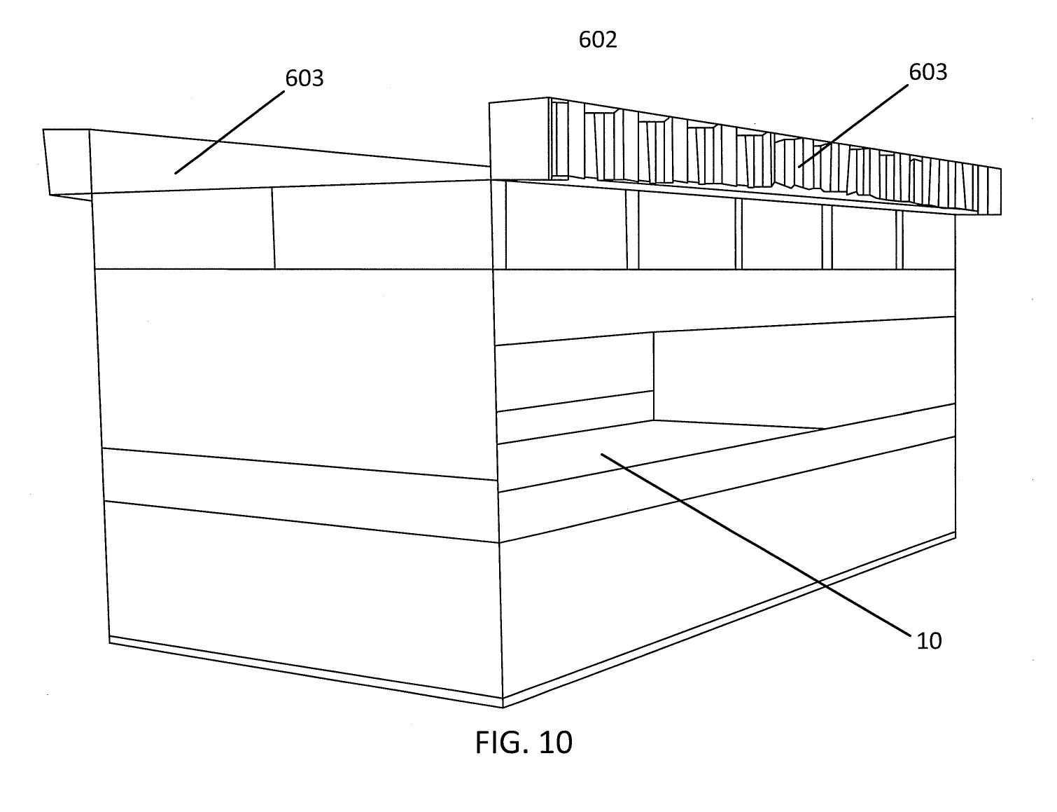

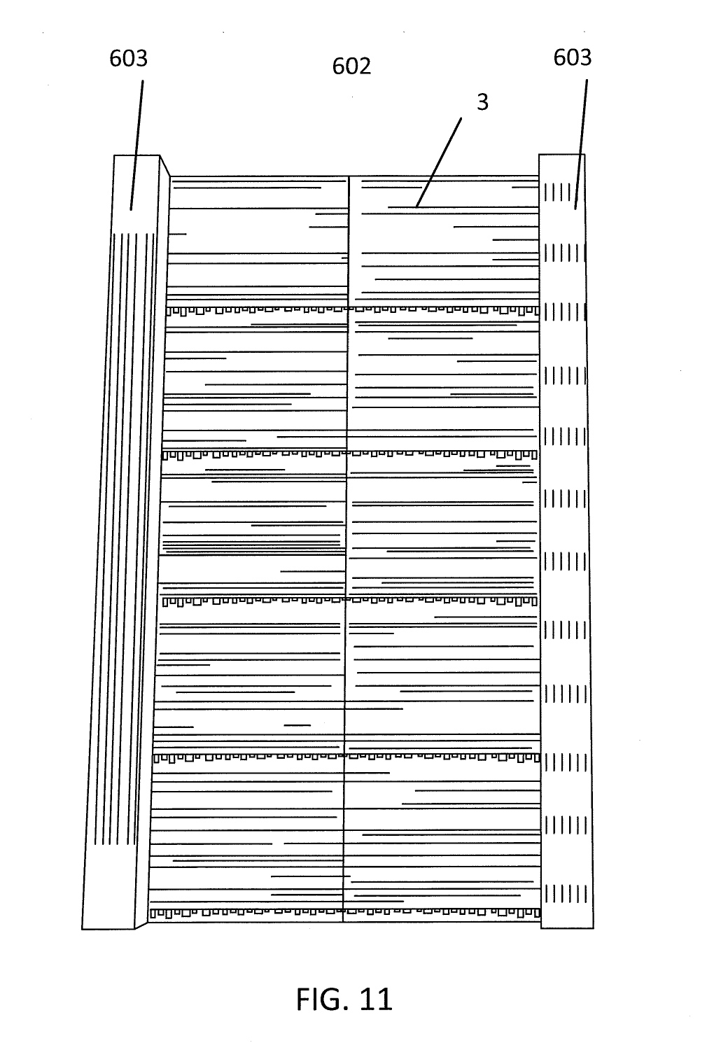

FIGS. 6-12 show examples of physical structures that may house and/or incorporate the systems described schematically in FIGS. 1-5. For example, FIG. 6 shows a perspective view of a structure 600 configured to house a refrigeration system according to an embodiment of the disclosure. Structure 600 may include an HVAC section 601, which may house refrigeration loop 100 and/or portions thereof, second refrigeration loop 500 and/or portions thereof, fan(s) 6, control electronics, and/or other elements of system 200. Structure 600 may also include a collecting section 602, which may house evaporator coils 3 and/or additional water handling equipment (e.g., equipment 400), such as water storage tank 10. Cross flow air exchangers 5 and 8 may be disposed in an open section 603 of collecting section 602. Air may be able to flow into and out of structure 600 through cross flow air exchangers 5 and 8 of open section 603. The configuration of structure 600 may be mirrored on a reverse side (e.g., there may be two open sections 603 in collecting section 602 on opposite sides of structure 600, respectively).

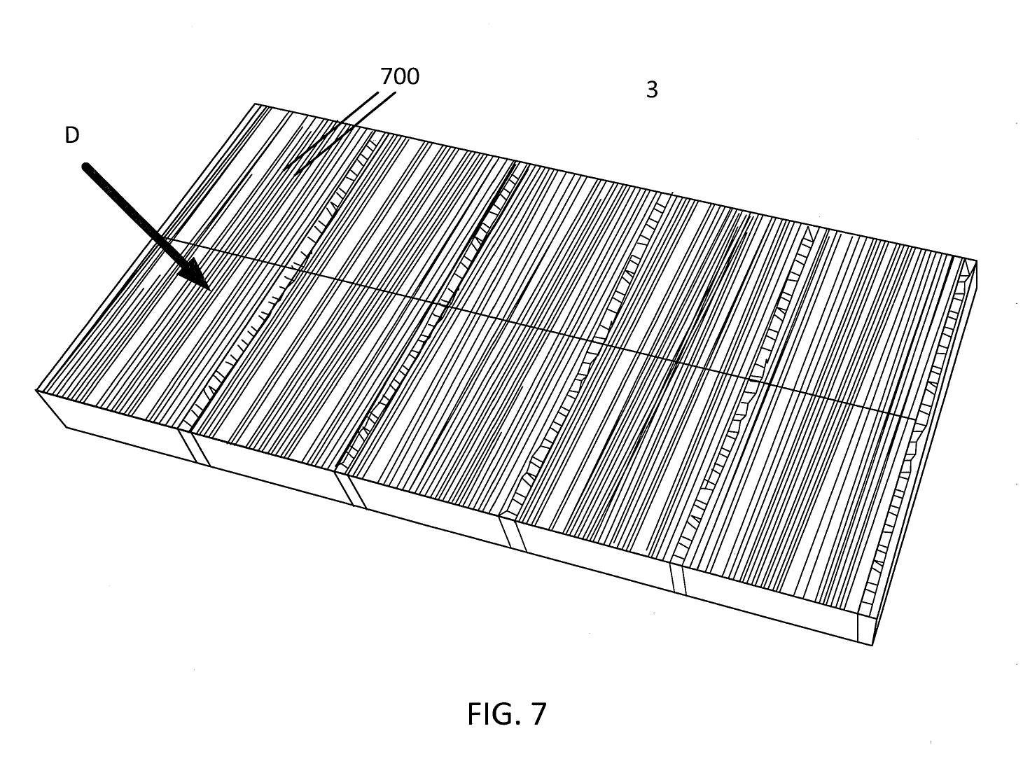

FIG. 7 shows a perspective view of an evaporator coil 3 according to an embodiment of the disclosure. Evaporator coil 3 may be configured as a condenser that may condense water vapor in hot air into liquid water at a cooler temperature through the processes described above, for example. Evaporator coil 3 may have an open configuration between individual coils 700 to allow collected water to drip in a downward direction (e.g., indicated by arrow D in FIG. 7).

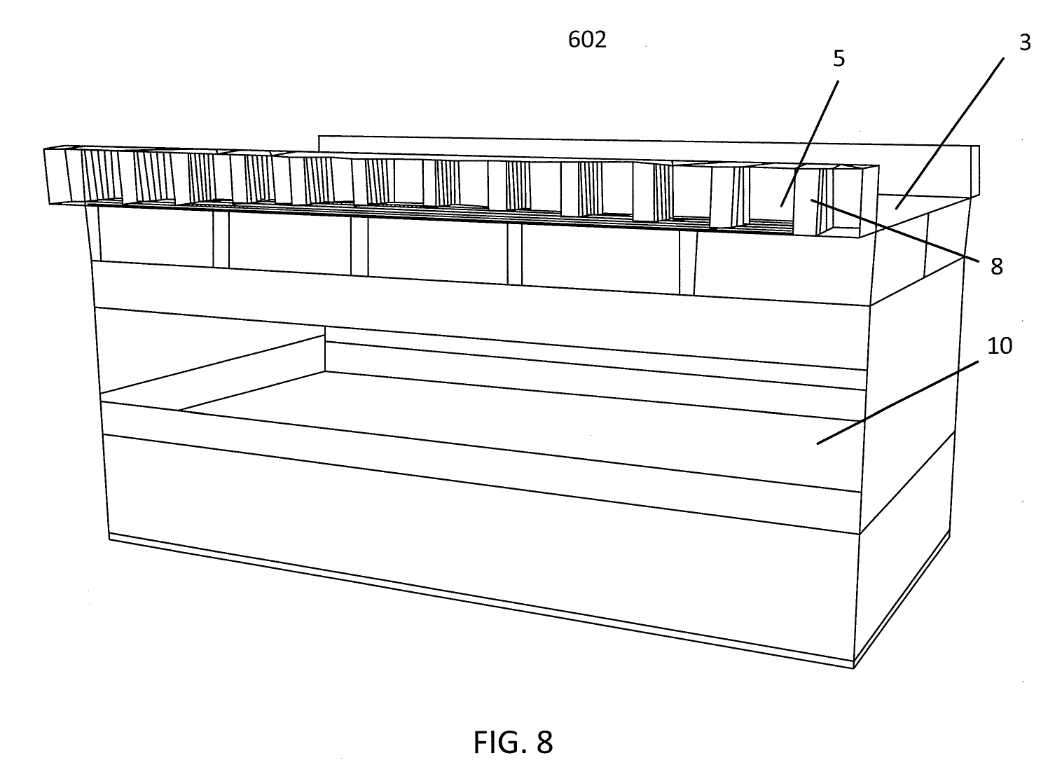

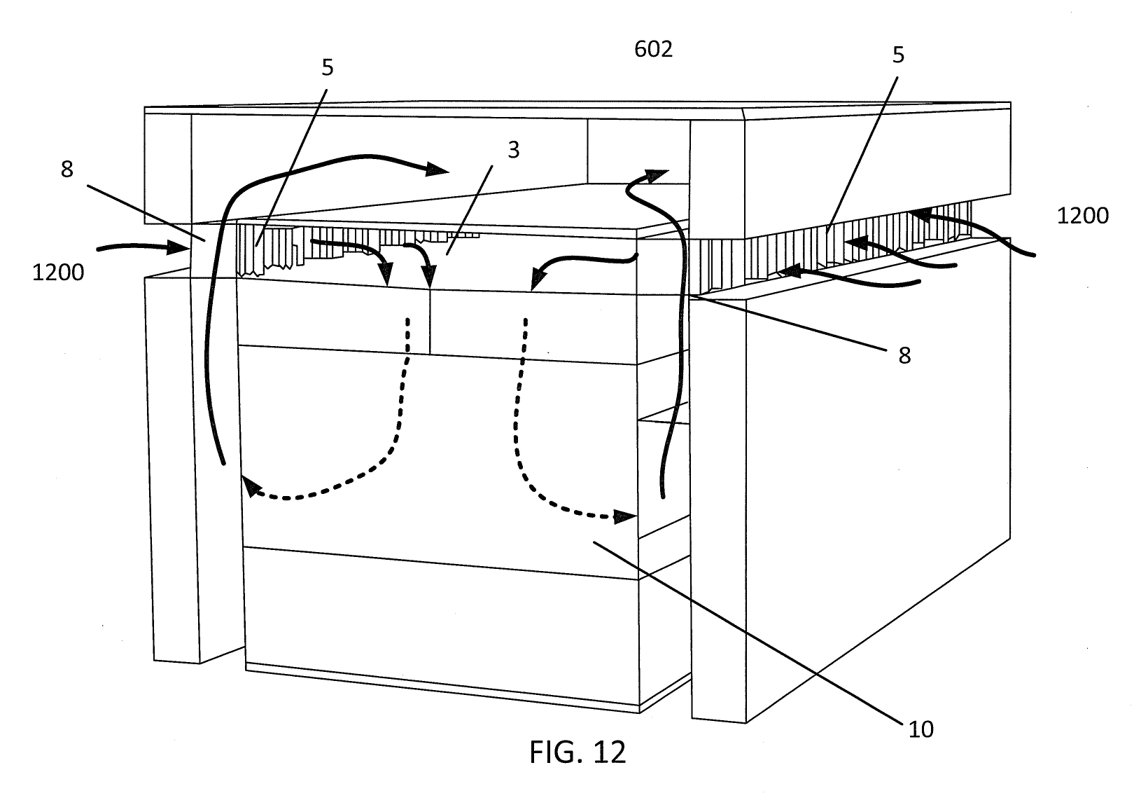

FIGS. 8-12 show cutaway views of a structure 600 configured to house a refrigeration system according to an embodiment of the disclosure. For example, in FIGS. 8-11, cutaway views of collecting section 602 illustrate the relationship of evaporator coil 3 to cross flow air exchangers 5 and 8. As described above, warm air may be pulled in through exchangers 5 and over cold coil 3 to produce water, then through the loop and out exchangers 8. Water may drip down from evaporator coil 3 into storage tank 10. FIG. 12 illustrates an airflow path 1200, with warm air entering through exchangers 5 and leaving through exchangers 8.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. An apparatus for recovering water from air comprising:
a refrigerator cycle including a condenser and an evaporator;
a cross flow heat exchanger constructed and arranged to pass air in first and second directions and transfer energy between air in the first direction and air in the second direction; and
a fan constructed and arranged to draw air from the evaporator over the condenser and to create air flow through the cross flow heat exchanger in the first direction, past the evaporator, through the cross flow heat exchanger in the second direction, and past the condenser,
wherein the evaporator causes water in the air to condense.

2. The apparatus of claim 1, further comprising:
a second cross flow heat exchanger constructed and arranged to pass air in third and fourth directions and transfer energy between air in the third direction and air in the fourth direction,
wherein the fan is constructed and arranged to create air flow through the second cross flow heat exchanger in the third direction, through the cross flow heat exchanger in the first direction, past the evaporator, through the cross flow heat exchanger in the second direction, past the condenser, and through the second cross flow heat exchanger in the fourth direction.

3. The apparatus of claim 1, further comprising a chlorinator constructed and arranged to treat water condensed by the evaporator.

4. The apparatus of claim 3, further comprising a storage tank coupled to the chlorinator.

5. The apparatus of claim 3, further comprising a second chlorinator constructed and arranged to further chlorinate water that has been treated by the chlorinator.

6. The apparatus of claim 1, further comprising a carbon filter constructed and arranged to filter the condensed water.

7. A method for recovering water from air comprising:
operating a refrigerator cycle including a condenser and an evaporator;
passing, by a cross flow heat exchanger, air in first and second directions and transferring, by the cross flow heat exchanger, energy between air in the first direction and air in the second direction;
drawing air from the evaporator over the condenser, thereby creating air flow through the cross flow heat exchanger in the first direction, past the evaporator, through the cross flow heat exchanger in the second direction, and past the condenser,
wherein the evaporator causes water in the air to condense.

8. The method of claim 7, wherein the drawing air is performed by operating a fan.

9. The method of claim 8, further comprising:
passing, by a second cross flow heat exchanger, air in third and fourth directions and transferring, by the second cross flow heat exchanger, energy between air in the third direction and air in the fourth direction,
wherein the operating of the fan creates air flow through the second cross flow heat exchanger in the third direction, through the cross flow heat exchanger in the first direction, past the evaporator, through the cross flow heat exchanger in the second direction, past the condenser, and through the second cross flow heat exchanger in the fourth direction.

10. The method of claim 7, further comprising treating water condensed by the evaporator with a chlorinator.

11. The method of claim 10, further comprising further chlorinating water that has been treated by the chlorinator with a second chlorinator.

12. The method of claim 7, further comprising filtering the condensed water with a carbon filter.

13. An apparatus for recovering water from air comprising:
operating a primary refrigerator cycle including a condenser and an evaporator;
operating a secondary refrigerant loop including a secondary heat exchanger, a secondary pump, and a refrigerant disposed in the secondary refrigerant loop, the secondary refrigerant loop including a portion cooled by the evaporator;
passing, by a cross flow heat exchanger, air in first and second directions and transferring, by the cross flow heat exchanger, energy between air in the first direction and air in the second direction; and
a fan constructed and arranged to draw air from the secondary heat exchanger over the condenser and to create air flow through the cross flow heat exchanger in the first direction, past the secondary heat exchanger, through the cross flow heat exchanger in the second direction, and past the condenser,
wherein the secondary heat exchanger causes water in the air to condense.

14. The apparatus of claim 13, wherein the refrigerant includes glycol.

15. The apparatus of claim 14, wherein the glycol includes ethylene glycol.

16. A method for recovering water from air comprising:
a primary refrigerator cycle including a condenser and an evaporator;
a secondary refrigerant loop including a secondary heat exchanger, a secondary pump, and a refrigerant disposed in the secondary refrigerant loop, the secondary refrigerant loop including a portion cooled by the evaporator;
a cross flow heat exchanger constructed and arranged to pass air in first and second directions and transfer energy between air in the first direction and air in the second direction; and
drawing air from the secondary heat exchanger over the condenser, thereby creating air flow through the cross flow heat exchanger in the first direction, past the secondary heat exchanger, through the cross flow heat exchanger in the second direction, and past the condenser,
wherein the secondary heat exchanger causes water in the air to condense.

17. The method of claim 16, wherein the drawing air is performed by operating a fan.
